(19) United States
(12) Patent Application Publication
(10) Pub. No.: US 2018/0159178 A1
(43) Pub. Date: Jun. 7, 2018

(54) BATTERY WITH COATED ACTIVE MATERIAL

(71) Applicant: ZAF Energy Systems, Incorporated, Columbia Falls, MT (US)

(72) Inventors: Adam Weisenstein, Kalispell, MT (US); Zachary Favors, Reno, NV (US); Fabio Albano, Playa Vista, CA (US); Melissa D. McIntyre, Butte, MT (US); Cody Ryan Carter, Kalispell, MT (US); Howard F. Wilkins, Kalispell, MT (US)

(21) Appl. No.: 15/833,605

(22) Filed: Dec. 6, 2017

Related U.S. Application Data
(60) Provisional application No. 62/430,624, filed on Dec. 6, 2016.

(51) Int. Cl. H01M 10/30; H01M 10/32; H01M 6/18

(52) U.S. Cl. CPC H01M 10/30; H01M 2/022; H01M 6/18; H01M 10/32

(57) ABSTRACT

An anode of a battery includes active material particles each coated with a metal oxide to form a nanoscale conformal shell there around. The shells are configured to, during charge, confine reduction of the active material particles to within the shells and to prevent dendritic growth and shape change.

### CROSS-REFERENCE TO RELATED APPLICATION

This application claims the benefit of U.S. Provisional Application Ser. No. 62/430,624 filed Dec. 6, 2016.

### TECHNICAL FIELD

This disclosure relates to batteries and electrodes therefor.

### BACKGROUND

Primary cells are designed to be used once and discarded. Generally speaking, the electrochemical reactions occurring in the cells are not reversible: As a primary cell is used, the reactions therein use up the chemicals that generate power and irreversible reaction products.

Secondary cells facilitate reversible cell reactions that allow them to recharge, or regain their cell potential, through the work done by passing currents of electricity and converting the products back to reactant status. As opposed to primary cells that experience irreversible electrochemical reactions such as gassing, secondary cell reactions can be reversed allowing for numerous charges and discharges.

### SUMMARY

A battery includes an electrode assembly. The electrode assembly includes an anode, a cathode, and a separator. The anode includes active material particles each coated with a metal oxide to form a nanoscale conformal shell there around that, during charge, confines reduction of the active material particle to within the shell and prevents dendritic growth and shape change.

A battery includes an electrode assembly. The electrode assembly includes an anode, a cathode, and a separator. The cathode includes active material particles each coated with a metal oxide to form a nanoscale conformal shell there around that chemically stabilizes the active material particle within the shell and prevents shape change.

An electrode assembly includes a plurality of active material particles each encased in a nanoscale conformal shell that, during charge, confines reduction of the active material particle to within the shell and prevents shape and/or phase change. The active material particles are held together with a binder to form a porous structure. The nanoscale conformal shell is a perovskite, phosphate salt, spinel, or an olivine. The electrode assembly also includes an alkaline electrolyte occupying void spaces defined by the porous structure.

### BRIEF DESCRIPTION OF THE DRAWINGS

FIG. 1 is a schematic diagram of a battery.

FIG. 2A is an illustration of active material before and after coating.

FIG. 2B is an illustration, in cross-section, of a metal oxide coated active material particle.

FIGS. 3 and 4 are side views, in cross-section, of portions of other batteries.

### DETAILED DESCRIPTION

Various embodiments of the present disclosure are described herein. However, the disclosed embodiments are merely exemplary and other embodiments may take various and alternative forms that are not explicitly illustrated or described. The figures are not necessarily to scale; some features may be exaggerated or minimized to show details of particular components. Therefore, specific structural and functional details disclosed herein are not to be interpreted as limiting, but merely as a representative basis for teaching one of ordinary skill in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. However, various combinations and modifications of the features consistent with the teachings of this disclosure may be desired for particular applications or implementations.

With reference to FIG. 1, a battery 10 includes an anode 12, cathode 14, and separator 16 disposed there between—each of which is bathed in electrolyte 18 and contained by housing 19. Collectively, the anode 12, cathode 14, and separator 16 may be referred to as an electrode assembly 20. The anode 12 and cathode 14 can be electrically connected via circuitry 22. As the name suggests, the separator 16 physically separates the anode 12 and cathode 14. Ions, however, may travel thereacross. During discharge, ions may travel from the cathode 14, through the separator 16, and to the anode 12. During charge, the ions may travel from the anode 12, through the separator 16, and to the cathode 14. The flow of current through the circuity 22 accompanies this process.

In the case in which zinc oxide (ZnO) is the active material for the anode 12 and the electrolyte 18 is an alkaline electrolyte, zinc forms zincate ions (Zn(OH)₄²—) upon discharge which are soluble in the alkaline electrolyte 18 and may migrate over time to other positions in the battery 10. With cycling, this zinc dissolution and precipitation may lead to anode shape change and consequently a gradual loss in capacity. Additionally, ZnO can precipitate in dendrite form, which leads to dead zinc and possible cell shorting. Traditionally, additives such as calcium hydroxide have been implemented to chemically bind zincate ions, but this requires large quantities of inactive material to bind all zincate ions stoichiometrically. This, however, could significantly lower the energy of the battery 10.

Here ZnO particles, for example, are coated by metal oxide species (e.g., Al₂O₃, CeO₂, Cr₂O₃, Ga₂O₃, HfO₂, In₂O₃, La₂O₃, MnO₂, MoO₂, SnO₂, TiO₂, V₂O₅, Y₂O₃, ZrO₂), perovskites (e.g., M^{I}M^{II}O₃, where M^{I}=Ba, Ca, La, Sr, etc., or M^{II}=Co, Mn, Mo, Ti, V, etc.), phosphate salts (e.g., MPO₄, where M=Co, Li₃, Ni, V, etc.), spinels (e.g., M^{II}M^{III}₂O₄,where M^{I}=Fe, Mg, Mn, Ni, Zn, Co, etc., or M^{II}=Al, Cr, Fe, Mn, Ti, etc.) or olivines (e.g, M^{I}₂M^{II}O₄, where M^{I}=Ba, Ca, K, Li, Mg, Sr, etc., or M^{II}=Al, Co, Fe, Mn, Mo, Ni, V) via atomic layer deposition, co-precipitation, or sol-gel, etc., in order to suppress the dissolution of zinc and formation of zinc dendrites. This conformal coating can be in the range of 1-100 nanometers thick. The use of such a coating permits the use of non-stoichiometric amounts of inactive additives, which significantly increases the percentage of active material (e.g., ZnO) in the anode 12. These coatings are chemically and mechanically stable, and ionically conductive in the alkaline electrolyte 18 and may additionally suppress hydrogen evolution at the anode 12 and increase electronic conductivity. The coated ZnO particles, and other such particles, can be implemented in nickel-zinc batteries, silver-zinc batteries, and zinc-air batteries to improve cycle life and increase energy.

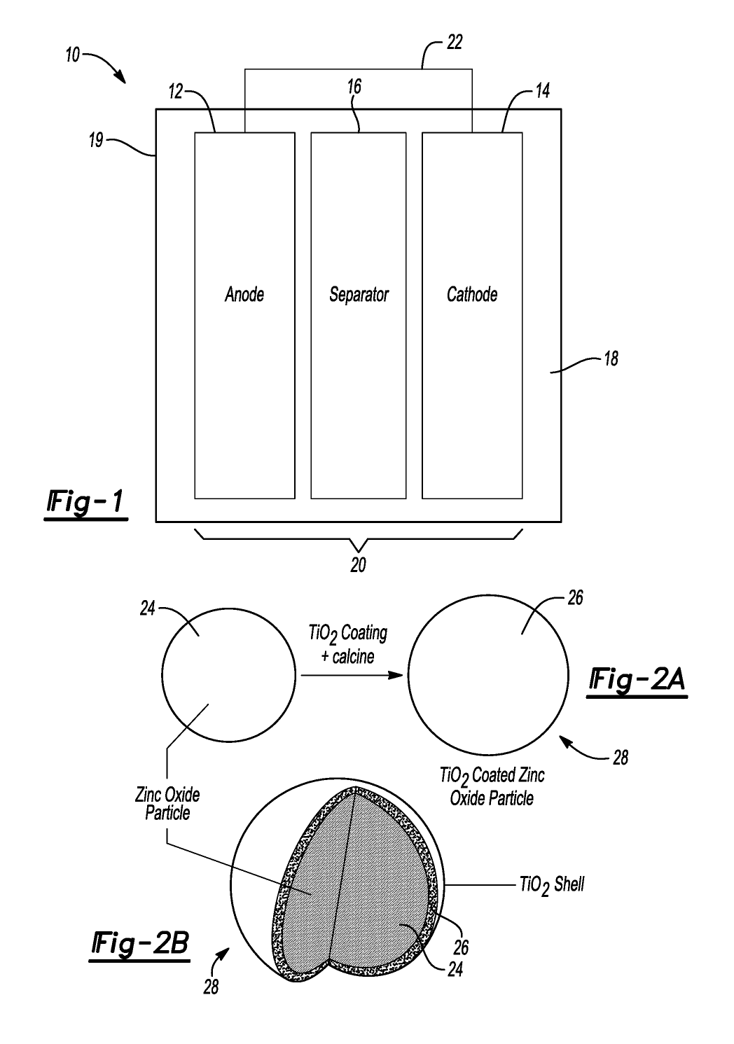

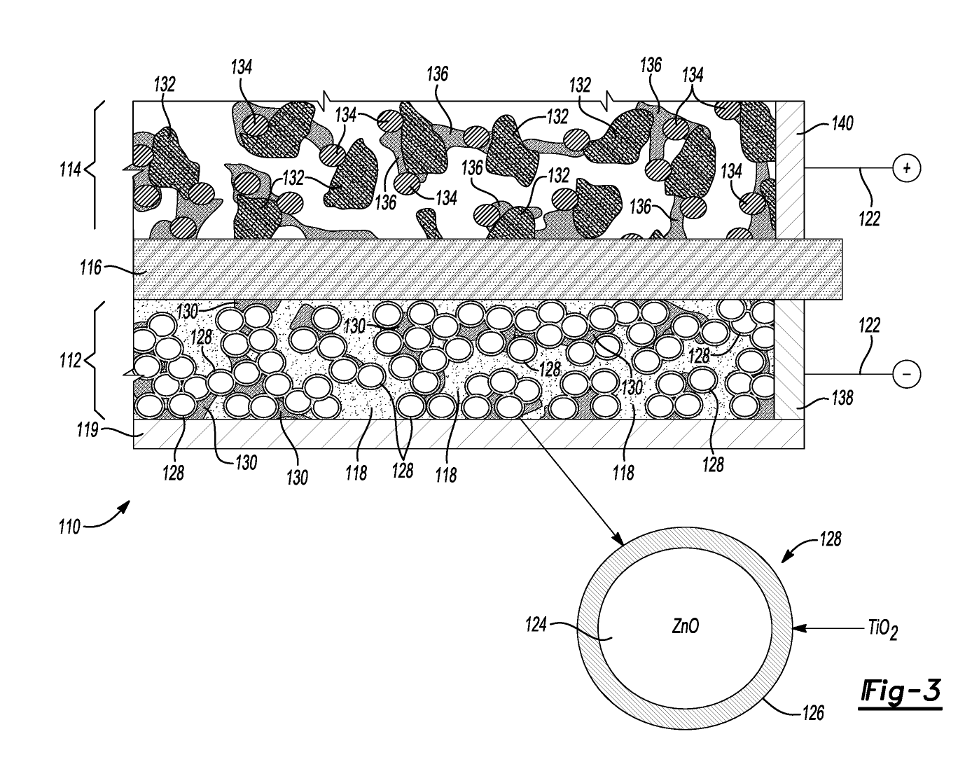

With reference to FIG. 2A, an active material particle 24 (a ZnO particle in this example) is shown before and after coating (and calcining) with TiO₂, which forms a shell 26 that contains the active material particle 24 and results in a coated particle 28. Anode active materials that may be subject to such coating may include metal oxides (e.g., aluminum, zinc, iron, bismuth, cadmium, gallium, indium, lead, and silicon oxides, etc.). Likewise, cathode active materials that may be subject to such coating may include active carbons, hydroxides (e.g., M(OH)₂, where M=Al, Co, Fe, Mn, Ni, etc.), perovskites (e.g., M^{I}M^{II}O₃, where M^{I}=Ba, Ca, La, Sr, etc., or M^{II}=Co, Mn, Mo, Ti, V, etc.), spinels (e.g., M^{II}M^{III}₂O₄, where M^{I}=Co, Fe, Mg, Mn, Ni, Zn, etc., or M^{II}=Al, Cr, Fe, Mn, Ti, etc.), or transition metal oxides (e.g., LiCoO₂, LiMn₂O₄, LiMn_{0.33}Co_{0.33}Ni_{0.33}O₂, etc.).

A variety of coating techniques may be used including atomic layer deposition, evaporation, chemical vapor deposition, laser ablation, microwave plasma enhanced chemical vapor deposition, physical vapor deposition, plasma spraying, pulsed laser deposition, radio frequency magnetron sputtering, spray coating sputtering, spray deposition, or spray pyrolysis. Wet chemistry techniques may also be used including co-precipitation, fluidized bed reaction, glycine nitrate combustion synthesis, the Pechini method, or sol-gel.

With reference to FIG. 2B, reduction of the active material particle 24 is confined to within the shell 26 during charge, which prevents dendritic growth and shape change within the electrode assembly. Such coated particles 28 can be formed into anodes, cathodes, or both.

With reference to FIG. 3, a battery 110 includes an anode structure 112, a cathode structure 114, and a separator 116 disposed there between. In this example, the anode structure 114 includes coated particles 128 (e.g., active material particles 124 each coated with a shell 126 as described herein) held together via a binder 130 to form a porous structure defining void spaces occupied by electrolyte 118. And, the cathode structure 114 includes a scaffold 132, catalyst particles 134 in contact with the scaffold 132, and a binder/plasticizer 136 connecting the particles 134 to the scaffold 132. (Other anode and/or cathode structures are of course contemplated.) A porosity of the scaffold 132 is such that void spaces (fluid passageways) facilitate flow there through. The battery 110 further includes anode and cathode current collector tabs 138, 140 respectively adjacent to the anode and cathode structures 112, 114, and circuitry 122 to facilitate the flow of current during operation.

Candidate scaffolds include carbon fiber, carbon foam, conductive ceramics, conductive plastics, copper or nickel fiber, copper or nickel foam, copper or nickel mesh, copper or nickel punched metal, expanded metal, gold plated structures, platinum plated steel (or other metal), sintered nickel powder, titanium fibers, etc. Candidate catalyst particles include activated carbons, carbon blacks, graphites, hard carbons, hydroxides, metal oxides, perovskites, spinels, etc. And, candidate binders/plasticizers include acrylic and aromatic binders, carboxymethyl cellulose, perfluoropolyether, polyethylene glycol, polytetrafluoroethylene, polyvinyl alcohol, polyvinyl chloride, polyvinylidene fluoride, various ionomers, etc.

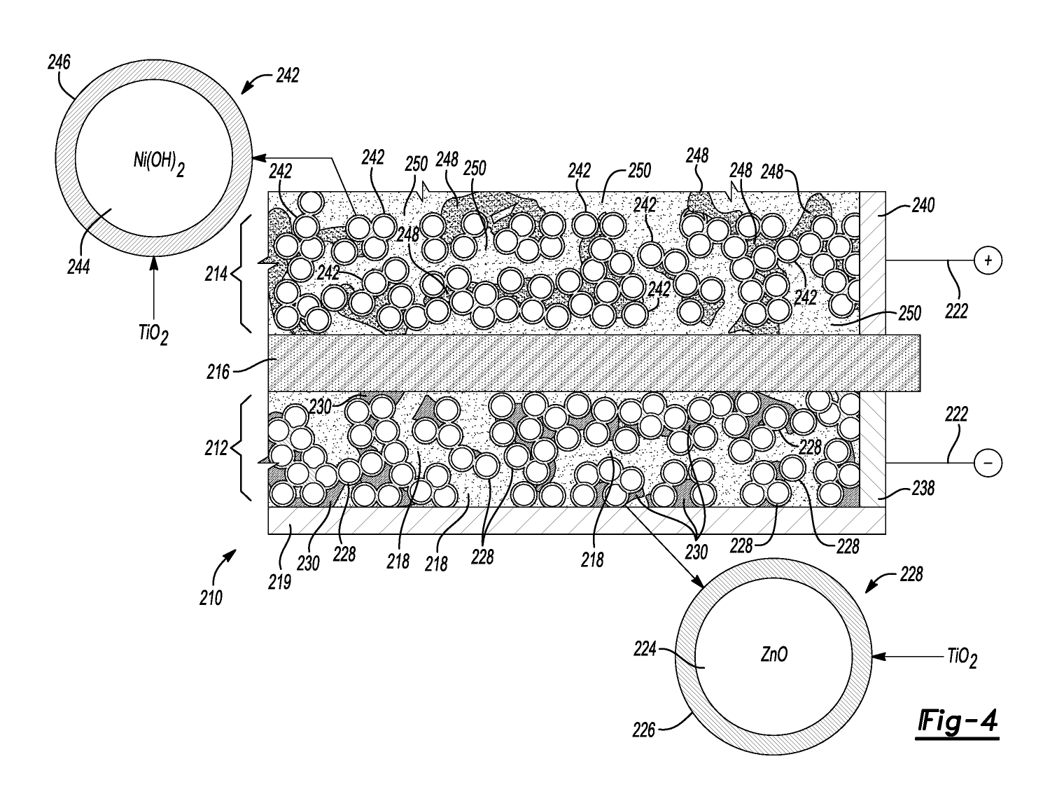

With reference to FIG. 4, a battery 210 includes an anode structure 212, a cathode structure 214, and a separator 216 disposed there between. In this example, the anode structure 212 includes coated particles 228 (e.g., active material particles 224 each coated with a shell 226 as described herein) held together via a binder 230 to form a porous structure defining void spaces occupied by electrolyte 218. And, the cathode structure 214 includes coated particles 242 (e.g., hydroxide particles 244 each coated with a shell 246 as described herein) held together via a binder 248 to form a porous structure defining void spaces occupied by electrolyte 250. In addition to preventing shape change, the shells 246 also chemically and mechanically stabilize the hydroxide particles 244 (e.g., prevent phase change, etc.) therein. The battery 210 further includes anode and cathode current collector tabs 238, 240 respectively adjacent to the anode and cathode structures 212, 214, and circuitry 222 to facilitate the flow of current during operation.

Various techniques may be used for electrode structure fabrication including dip coating, dry pressing, infiltration, microgravure, screen printing, slot dye casting, spin coating, spray coating, tape casting, etc.

While exemplary embodiments are described above, it is not intended that these embodiments describe all possible forms encompassed by the claims. The words used in the specification are words of description rather than limitation, and it is understood that various changes may be made without departing from the spirit and scope of the disclosure and claims. As previously described, the features of various embodiments may be combined to form further embodiments that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes include, but are not limited to appearance, cost, durability, ease of assembly, life cycle cost, manufacturability, marketability, packaging, serviceability, size, strength, weight, etc. As such, embodiments described as less desirable than other embodiments or prior art implementations with respect to one or more characteristics are not outside the scope of the disclosure and may be desirable for particular applications.

What is claimed is:

1. A battery comprising:
an electrode assembly including an anode, a cathode, and a separator, wherein the anode includes active material particles each coated with a metal oxide to form a nanoscale conformal shell there around configured to, during charge, confine reduction of the active material particle to within the shell and to prevent dendritic growth and shape change.

2. The battery of claim 1, wherein the active material particles include metal oxides.

3. The battery of claim 1, wherein the metal oxide is Al₂O₃, CeO₂, Cr₂O₃, Ga₂O₃, HfO₂, In₂O₃, La₂O₃, MnO₂, MoO₂, SnO₂, TiO₂, V₂O₅, Y₂O₃, or ZrO₂.

4. The battery of claim 1, wherein the metal oxide is chemically and mechanically stable, and ionically conductive in an alkaline electrolyte.

5. The battery of claim 1, wherein the nanoscale conformal shell has a thickness of 1 to 100 nanometers.

6. The battery of claim 1, wherein the battery is a nickel-zinc battery, a silver-zinc battery, or a zinc-air battery.

7. A battery comprising:
an electrode assembly including an anode, a cathode, and a separator, wherein the cathode includes active material particles each coated with a metal oxide to form a nanoscale conformal shell there around configured to chemically stabilize the active material particle within the shell and to prevent shape change.

8. The battery of claim 7, wherein the active material particles include active carbons, hydroxides, perovskites, spinels, or transition metal oxides.

9. The battery of claim 7, wherein the metal oxide is Al₂O₃, CeO₂, Cr₂O₃, Ga₂O₃, HfO₂, In₂O₃, La₂O₃, MnO₂, MoO₂, SnO₂, TiO₂, V₂O₅, Y₂O₃, or ZrO₂.

10. The battery of claim 7, wherein the metal oxide is chemically and mechanically stable and conductive in an alkaline electrolyte.

11. The battery of claim 7, wherein the nanoscale conformal shell has a thickness of 1 to 100 nanometers.

12. The battery of claim 7, wherein the battery is a nickel-zinc battery, a silver-zinc battery, or a zinc-air battery.

13. An electrode assembly comprising:
a plurality of active material particles (i) each encased in a nanoscale conformal shell configured to, during charge, confine reduction of the active material particle to within the shell and to prevent shape change and (ii) held together with a binder to form a porous structure, wherein the nanoscale conformal shell is a perovskite, phosphate salt, spinel, or an olivine; and
an alkaline electrolyte occupying void spaces defined by the porous structure.

14. The assembly of claim 13, wherein the active material particles include transition metal oxides.

15. The assembly of claim 13, wherein the nanoscale conformal shell has a thickness of 1 to 100 nanometers.
